(19) United States
(12) Patent Application Publication
(10) Pub. No.: US 2012/0057095 A1
(43) Pub. Date: Mar. 8, 2012

(54) LIGHTING DEVICE, DISPLAY DEVICE AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/318,841

(22) PCT Filed: Feb. 23, 2010
(86) PCT No.: PCT/JP2010/052732

§ 371 Date: Nov. 4, 2011

(30) Foreign Application Priority Data
May 15, 2009 (JP) 2009-118892

(51) Int. Cl. G02F 1/1335; G09F 13/04; F21V 7/00

(52) U.S. Cl. 349/61; 362/217.05; 362/97.1

(57) ABSTRACT

A lighting device of the present invention achieves power saving and provides illumination light without having local dark portions. A lighting device 12 of the present invention includes an elongated light source 17, a chassis 14 configured to house the light source 17 and have an opening 14b for light from the light source 17 to pass through, an optical member 15a provided to face the light source 17 and cover the opening 14b and having an edge portion 15e on an end in a longitudinal direction of the light source 17, and a first light reflecting portion 50 configured to reflect the light from the light source 17 and provided in the edge portion 15e such that light reflectance of the edge portion 15e is relatively higher than that of a portion adjacent to the edge portion 15e.

### TECHNICAL FIELD

The present invention relates to a lighting device, a display device and a television receiver.

### BACKGROUND ART

A liquid crystal panel included in a liquid crystal display device does not emit light, and thus a backlight device is required as a separate lighting device. The backlight device is arranged behind the liquid crystal panel (i.e., on a side opposite from a display surface side). It includes a chassis having an opening on a liquid crystal panel side, a plurality of light sources (for example, cold cathode tubes) accommodated in the chassis as lamps, and an optical member (a diffuser and the like) provided at the opening of the chassis for efficiently directing light emitted from the light sources to a liquid crystal panel.

In such a backlight device including light sources emitting linear light, the optical member converts linear light into planer light to unify illumination light. However, if the linear light is not sufficiently converted into the planer light, striped lamp images are generated along the arrangement of the light sources, and this deteriorates display quality of the liquid crystal display device.

To obtain uniform illumination light from the backlight device, it is desirable to increase the number of light sources and reduce a distance between the adjacent light sources or to increase a diffusion rate of a diffuser, for example. However, increase of the number of light sources increases a cost of the backlight device and also increases power consumption. Increase of the diffusion rate of the diffuser fails to improve brightness and causes the problem that the number of light sourced is required to be increased. A backlight device disclosed in Patent Document 1 has been known as one that suppresses power consumption and ensures uniform luminance.

The backlight device described in Patent Document 1 includes a diffuser provided on a light output side of a plurality of light sources. A dimming dot pattern having a light transmission rate (opening rate) from 62 to 71% and haze from 90 to 99% is printed on the light diffuser. A dot diameter of each dot is great directly above the light sources and the dot diameter becomes smaller as is farther from the light source. With such a configuration, the light emitted from the light sources is efficiently used and the backlight device irradiates light having a sufficient brightness value and uniform luminance without increasing power consumption of the light source.
[Patent Document 1] Japanese Unexamined Patent Publication No. 2005-117023

### PROBLEM TO BE SOLVED BY THE INVENTION

In the device disclosed in Patent Document 1, a light source having relatively short length and having relatively a short luminous range is desired to be used to reduce power consumption. However, in such a relatively short light source, an end portion of the light source is located inside an edge portion of a diffuser (closer to an illumination area). In such a case, light emitted from the light source is less likely to reach the edge portion of the diffuser and a dark portion may be locally formed in illumination light. Such a local dark portion has remarkable difference in brightness from a bright portion and is easy to be recognized. This may deteriorate quality of the lighting device and visibility in the display device.

### DISCLOSURE OF THE PRESENT INVENTION

The present invention was made in view of the foregoing circumstances. An object of the present invention is to provide a lighting device that achieves power saving and provides illumination light without local dark portions. Another object of the present invention is to provide a display device including such a lighting device and a television receiver including such a display device.

### MEANS FOR SOLVING THE PROBLEM

To solve the above problem, a lighting device of the present invention includes a linearly formed light source, a chassis configured to house the light source and have an opening for light from the light source to pass through, and an optical member provided to face the light source and cover the opening and having an edge portion on an end in a longitudinal direction of the linearly formed light source, and a first light reflecting portion configured to reflect the light from the light source and provided in the edge portion such that light reflectance of the edge portion is relatively higher than that of a portion adjacent to the edge portion.

In most cases, the longitudinal end portions of the light source are non-luminous ranges from which light is not emitted and local dark portions are easy to be generated there. However, with the above configuration of the present invention, the first light reflecting portion having relatively high light reflectance is formed on the edge portions of the optical member that are close to the end portions of the light source, and therefore, light from the light source easily reflects off an entire area of the edge portions. Accordingly, the light from the light source is less likely to be transmitted through an entire area of the edge portions of the optical member and the illumination light is slightly darkened in an entire area of the edge portions. This suppresses occurrence of the local dark portions that are easily recognized. Especially, even in use of the light source having a length relatively shorter than the optical member, local dark portions are less likely to occur in the edge portions of the optical member, and this achieves power saving of the lighting device.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal display device provided in the television receiver;

FIG. 3 is a cross-sectional view of the liquid crystal display device along the short-side direction;

FIG. 4 is a cross-sectional view of the liquid crystal display device along the long-side direction;

FIG. 5 is a plan view illustrating a general construction of a hot cathode tube provided in the liquid crystal display device;

FIG. 6 is a plan view illustrating a general construction of a chassis provided in the liquid crystal display device;

FIG. 7 is a typical view illustrating an arrangement pattern of a first light reflecting portion and a second light reflecting portion formed on a surface of a diffuser provided in a backlight device that faces the hot cathode tube;

FIG. 8 is a plan view explaining a light reflectance distribution of a surface of the diffuser that faces the hot cathode tube;

FIG. 9 is a graph illustrating a light reflectance change in an A-A′ line of the diffuser in FIG. 8;

FIG. 10 is a graph illustrating a light reflectance change in a B-B′ line of the diffuser in FIG. 8;

FIG. 11 is a plan view explaining a light reflectance distribution of a surface of the diffuser facing the hot cathode tube according to one modification;

FIG. 12 is a graph illustrating a light reflectance change in a C-C′ line of the diffuser in FIG. 11;

FIG. 13 is a plan view illustrating an arrangement pattern of a hot cathode tube according to one modification;

FIG. 14 is a typical view illustrating an arrangement pattern of a first light reflecting portion and a second light reflecting portion formed on a surface of a diffuser provided that faces the hot cathode tube;

FIG. 15 is a plan view of a general construction of a chassis provided in a backlight device according to a second embodiment of the present invention;

FIG. 16 is a typical view illustrating an arrangement pattern of a first light reflecting portion and a second light reflecting portion formed on a surface of a diffuser that faces cold cathode tubes;

FIG. 17 is a graph illustrating a light reflectance change in a D-D′ line of the diffuser in FIG. 16;

FIG. 18 is a graph illustrating a light reflectance change in an E-E′ line of the diffuser in FIG. 16;

FIG. 19 is an exploded perspective view illustrating a general construction of a liquid crystal display device according to a third embodiment of the present invention;

FIG. 20 is a general plan view illustrating a chassis and an arrangement pattern of LED light sources provided in the liquid display device in FIG. 19;

FIG. 21 is a typical view illustrating an arrangement pattern of a first light reflecting portion and a second light reflecting portion formed on a surface of a diffuser provided in the liquid display device in FIG. 19 that faces the LED light sources;

FIG. 22 is a graph illustrating a light reflectance change in an F-F′ line of the diffuser;

FIG. 23 is a graph illustrating a light reflectance change in a G-G′ line of the diffuser;

FIG. 24 is a typical view illustrating an arrangement pattern of the LED light sources according to one modification; and

FIG. 25 is a typical view illustrating an arrangement pattern of the LED light sources according to another modification.

### BEST MODE FOR CARRYING OUT THE INVENTION

### First Embodiment

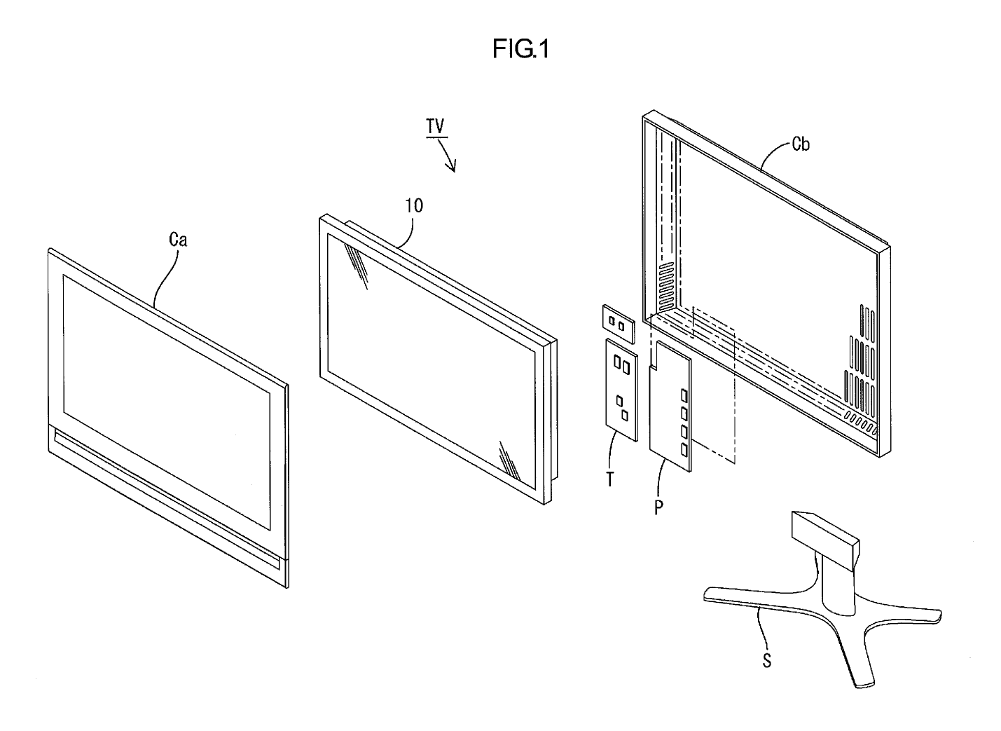

The first embodiment of the present invention will be explained with reference to FIGS. 1 to 10.

First, a construction of a television receiver TV including a liquid crystal display device 10 will be explained.

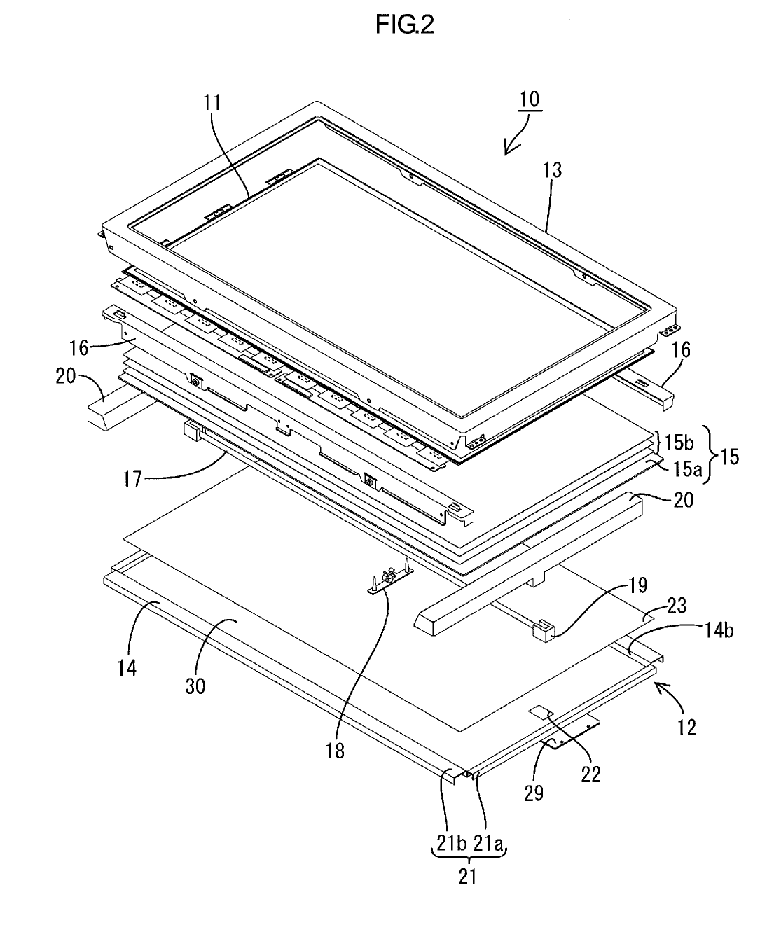

As illustrated in FIG. 1, the television receiver TV of the present embodiment includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position such that a short-side direction thereof matches a vertical line. As illustrated in FIG. 2, it includes a liquid crystal panel 11 as a display panel, and a backlight device 12 (lighting device), which is an external light source. They are integrally held by a frame-like bezel 13 and the like.

Next, the liquid crystal panel 11 and the backlight device 12 included in the liquid crystal display device 10 will be explained (see FIGS. 2 to 4).

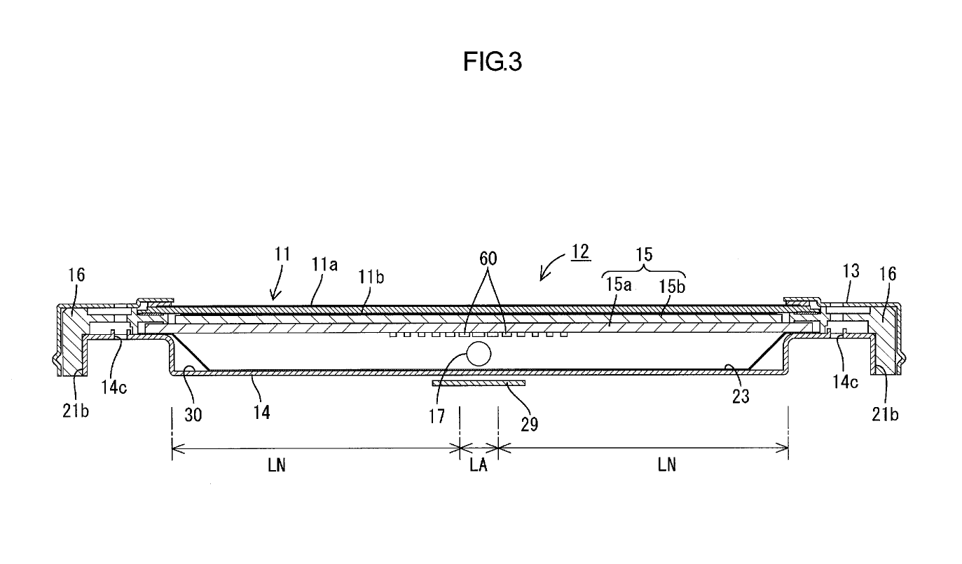

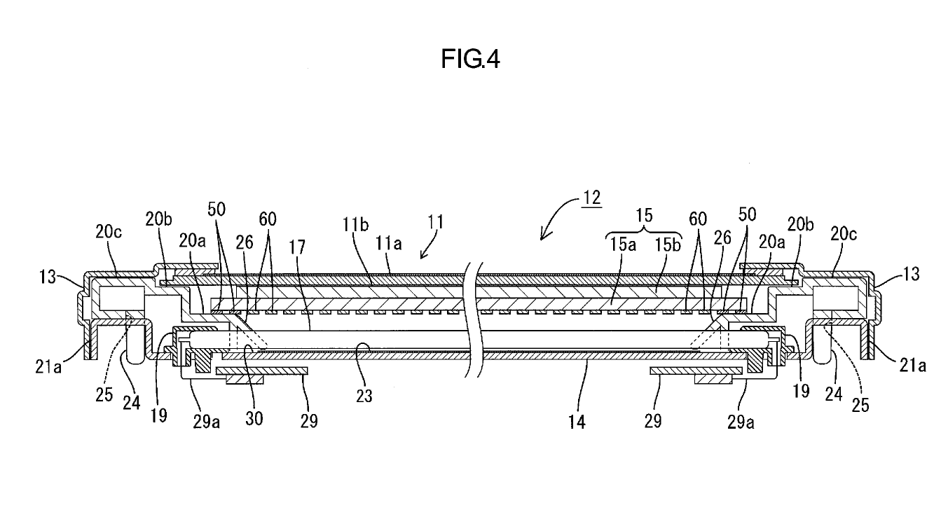

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 3 and 4).

As illustrated in FIG. 2, the backlight device 12 includes a chassis 14, an optical sheet set 15 (a diffuser (optical member, light diffuser member) 15a and a plurality of optical sheets 15b that are disposed between the diffuser 15a and the liquid crystal panel 11), and frames 16. The chassis 14 has a substantially box-shape and an opening 14b on the light output side (on the liquid crystal panel 11 side). The frames 16 arranged along the long sides of the chassis 14 hold the long-side edges of the diffuser 15a to the chassis 14. The long-side edges of the light guide plate 15a are sandwiched between the chassis 14 and the frames 16. A hot cathode tube (light source) 17, lamp clips 18, relay connectors 19 and lamp holders 20 are installed in the chassis 14. The lamp clips 18 are provided for mounting the hot cathode tube 17 to the chassis 14. The relay connectors 19 are connected to ends of the hot cathode tube 17 for making electrical connection. The lamp holder 20 collectively covers each end of the hot cathode tube 17 and the relay connector 19. A light exit side of the backlight device 12 is a side closer to the diffuser 15a than the hot cathode tube 17.

The chassis 14 is prepared by processing a metal plate. It is formed in a substantially shallow box shape. As illustrated in FIGS. 3 and 4, it includes a rectangular bottom plate 30 and outer rims 21, each of which extends upright from the corresponding side of the bottom plate 30 and has a substantially U shape. The outer rims 21 include short-side outer rims 21a and long-side outer rims 21b provided at the short sides and the long sides of the chassis 14, respectively. The bottom plate 30 of the chassis 14 has a plurality of mounting holes 22 along the long-side edges thereof. The relay connectors 19 are mounted in the mounting holes 22. As illustrated in FIG. 3, fixing holes 14c are provided on the upper surface of the chassis 14 along the long-side outer rims 21b to bind the bezel 13, the frames 16 and the chassis 14 together with screws and the like.

A light reflecting sheet 23 is disposed on an inner surface of the bottom plate 30 of the chassis 14 (on a side that faces the hot cathode tube 17). The light reflecting sheet 23 is a synthetic resin sheet having a surface in white color that provides high light reflectivity. The light reflecting sheet 23 is placed so as to cover almost entire inner surface of the bottom plate 30 of the chassis 14. As illustrated in FIG. 4, long-side edges of the light reflecting sheet 23 are lifted so as to cover the long-side outer rims 21b of the chassis 14 and sandwiched between the chassis 14 and the diffuser 15a. With this light reflecting sheet 23, light emitted from the hot cathode tubes 17 is reflected to the light guide plate 15a.

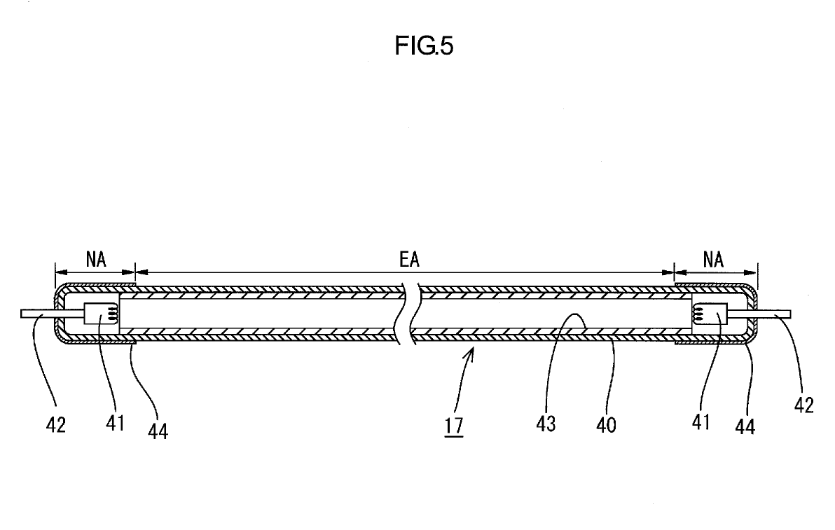

The hot cathode tube 17 is formed in an elongated tubular shape having a diameter of 15.5 mm. As illustrated in FIG. 5, the hot cathode tube 17 includes an elongated glass tube 40, electrodes 41 and outer leads 42. Two ends of the glass tube 40 are closed. The electrode 41 is enclosed inside of the glass tube 40 at each end. The outer lead 42 extends outside of the glass tube 40 from the electrode 41. Mercury is sealed inside the glass tube 40. Fluorescent material 43 is coated on an inner wall surface of the glass tube 40. Metal ferrules 44 are fitted to the two ends of the hot cathode tube 17, respectively. The two end portions of the hot cathode tube 17 in which the electrodes 41 are provided (the ferrules 44) are non-luminous ranges NA and the middle portion of the hot cathode tube 17 (the portion on which the fluorescent material 43 is coated) is the luminous range EA.

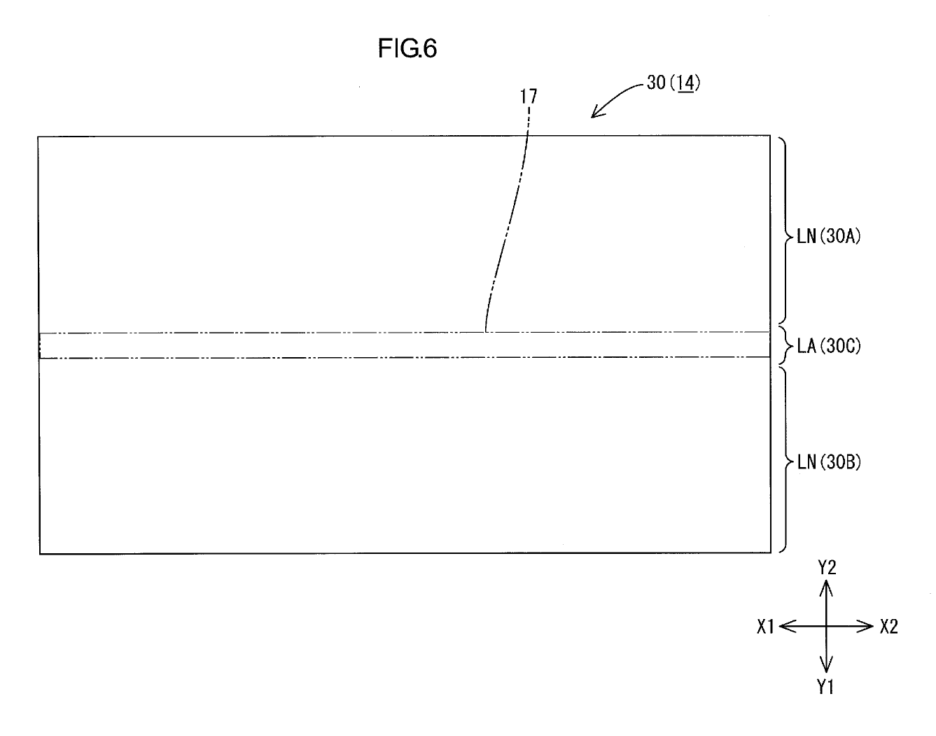

The hot cathode tube 17 is arranged in the chassis 14 such that the longitudinal direction (the axial direction) matches the long-side direction of the chassis 14. As illustrated in FIG. 6, the bottom plate 30 of the chassis 14 (the portion facing the diffuser 15a) is defined in three portions in the short-side direction of the chassis 14. The three portions include a first end portion 30A, a second end portion 30B that is located on an opposite side end from the first end portion 30A and a middle portion 30C that is sandwiched between the first end portion 30A and the second end portion 30B. The hot cathode tube 17 is arranged in the middle portion 30C of the bottom plate 30 and a light source installation area LA is formed there. No hot cathode tube 17 is arranged in the first end portion 30A and the second end portion 30B of the bottom plate 30 and an empty area LN is formed there. The hot cathode tube 17 is partially arranged in the middle portion of the bottom plate 30 of the chassis 14 to form the light source installation area LA. An area of the light source installation area LA is smaller than that of the empty area LN. A ratio of the area of the light source installation area LA occupying in the entire area of the bottom plate 30 of the chassis 14 is preferably set to be in a range from 4% to 37% for achieving power saving and ensuring brightness and is set to be 4% in this embodiment. The ratio may be changed according to the number of the hot cathode tubes 17.

On the outer surface of the bottom plate 30 of the chassis 14 (on a side opposite from the hot cathode tube 17), as illustrated in FIGS. 3 and 4, the inverter board set 29 is provided so as to overlap the light source installation area LA, more specifically to overlap each end of the hot cathode tube 17. Drive power is supplied from the inverter board set 29 to the hot cathode tube 17. Each end of the hot cathode tube 17 has a terminal (not shown) for receiving drive power and electrical connection between the terminal and a harness 29a (see FIG. 4) derived from the inverter board set 29 enables supply of high-voltage drive power. Such electrical connection is established in a relay connector 19 in which the end of the hot cathode tube 17 is fitted. The holders 20 are mounted so as to cover the relay connectors 19.

The holders 20 that cover the ends of the hot cathode tube 17 and the relay connectors 19 are made of white synthetic resin. Each of them has an elongated substantially box shape that extends along the short side of the chassis 14 as illustrated in FIG. 2. As illustrated in FIG. 4, each holder 20 has steps on the front side such that the diffuser 15a and the liquid crystal panel 11 are held at different levels. A part of the holder 20 is placed on top of a part of the corresponding short-side outer rim 21a of the chassis 14 and forms a side wall of the backlight device 12 together with the outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the outer rim 21a of the chassis 14.

The steps of the holder 20 that covers the end of the hot cathode tube 17 include three surfaces that are parallel to the bottom plate 30 of the chassis 14. The three surfaces include a first surface 20a, a second surface 20b and a third surface 20c. The short-side rim of the diffuser 15a is placed on the first surface 20a that is located at a lowest level. A slanted cover 26 extends from the first surface 20a toward the bottom plate 30 of the chassis 14 with being slanted. A short-side rim of the liquid crystal panel 11 is placed on the second surface 20b of the holder 20. The third surface 20c that is located at a highest level overlaps the outer rim 21a of the chassis 14 and comes in contact with the bezel 13.

On the opening 14b side of the chassis 14, the optical sheet set 15 including the diffuser (optical member, light diffusing member) 15a and the optical sheets 15b is provided. The diffuser 15a is configured by a plate-like member of synthetic resin and light scattering particles dispersed therein. The diffuser 15a diffuses linear light emitted from the hot cathode tube 17 that is a linear light source and also reflects light emitted from the hot cathode tube 17. Each of the short-side rims of the diffuser 15a is placed on the first surface 20a of the holder and does not receive a vertical force. Thus, the diffuser 15a covers the opening 14b of the chassis 14.

The optical sheets 15b provided on the diffuser 15a includes a diffuser sheet, a lens sheet and a reflection-type polarizing plate layered in this order from the diffuser 15a side. The optical sheets 15b convert the light that is emitted from the hot cathode tube 17 and passes through the diffuser 15a to planar light. The liquid crystal display panel 11 is disposed on the top surface of the top layer of the optical sheets 15b. The optical sheets 15b are held between the diffuser 15a and the liquid crystal panel 11.

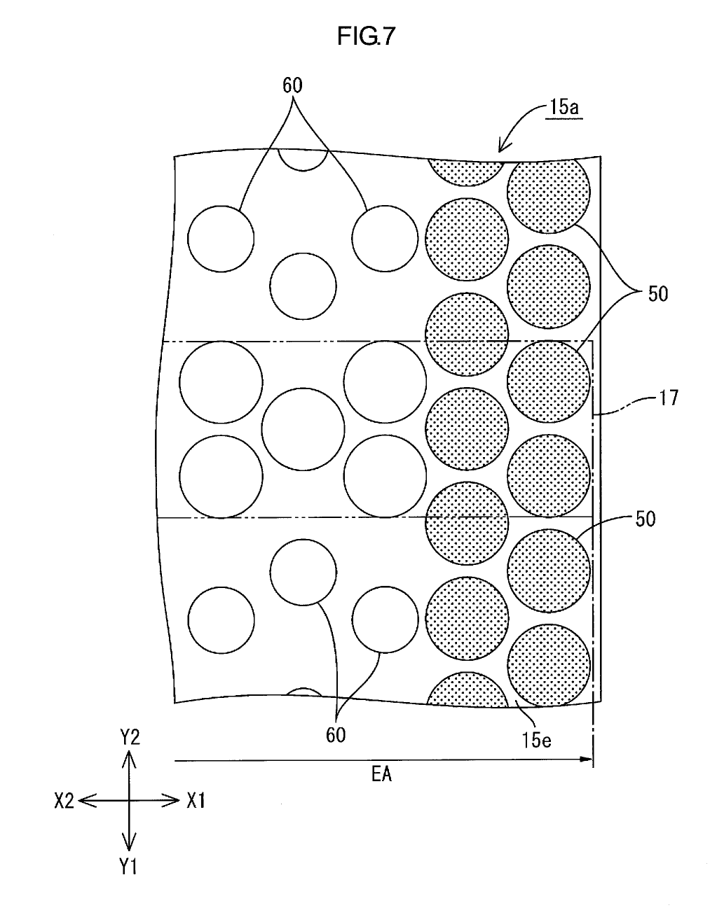

A light reflecting function of the diffuser 15a will be explained in detail with reference to FIGS. 7 to 10.

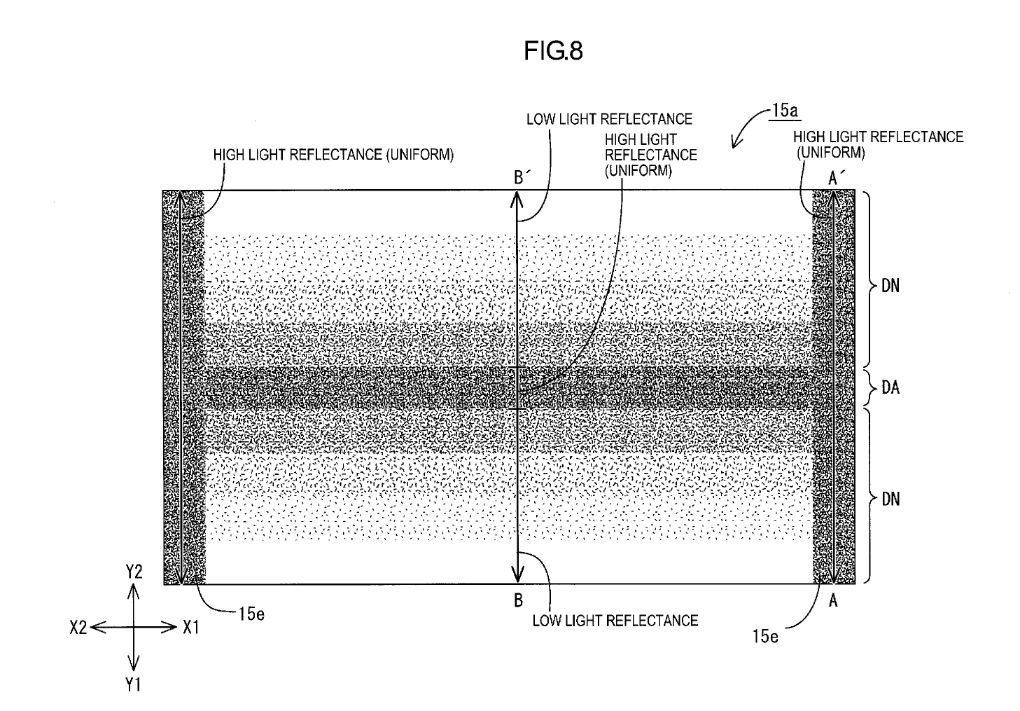

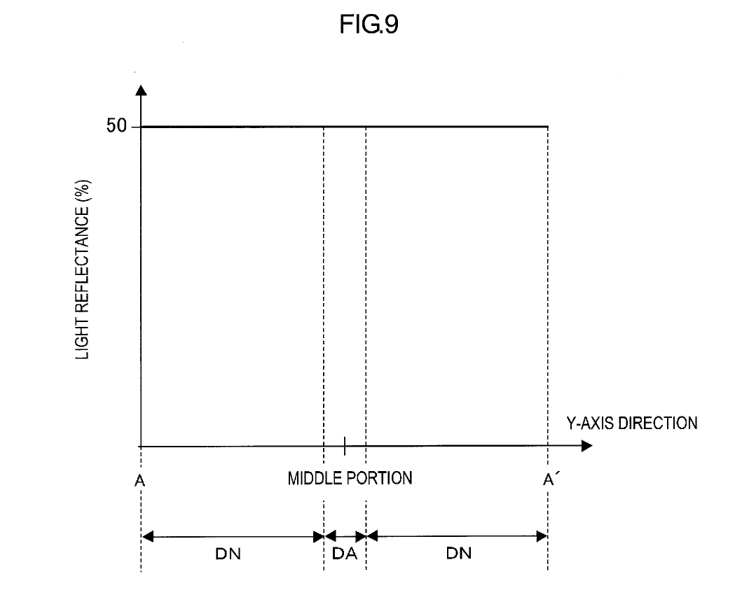

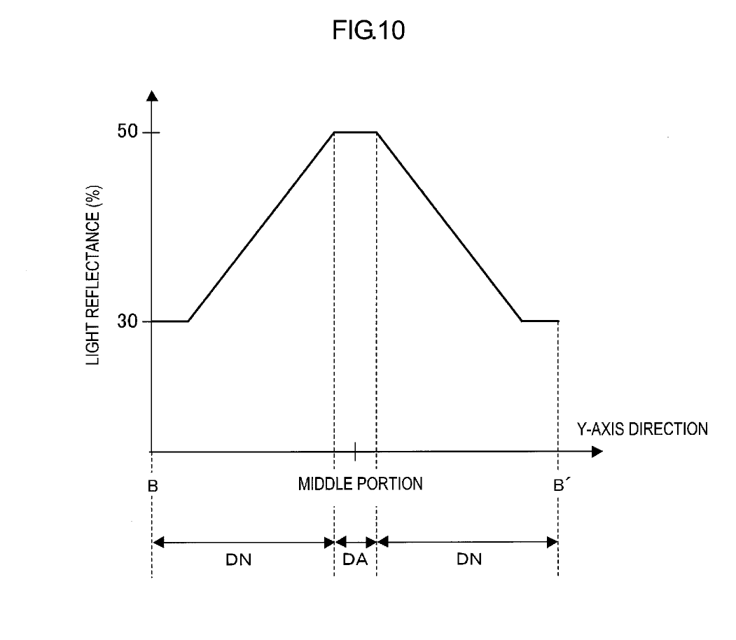

FIG. 7 is a typical view illustrating an arrangement pattern of a first light reflecting portion and a second light reflecting portion formed on a diffuser. FIG. 8 is a plan view explaining a light reflectance distribution of a surface of the diffuser facing the hot cathode tube. FIG. 9 is a graph illustrating a light reflectance change in an A-A′ line of the diffuser in FIG. 8. FIG. 10 is a graph illustrating a light reflectance change in a B-B′ line of the diffuser in FIG. 8. In FIGS. 7 to 10, the long-side direction of the diffuser is referred to as an X-axis direction and the short-side direction thereof is referred to as a Y-axis direction. In FIGS. 9 and 10, a horizontal axis shows the Y-axis direction (short-side direction) and the light reflectance is plotted on a graph from an end portion close to the Y1 (indicated by A or B) to a middle portion in the Y-axis direction and from the middle portion to an end portion closer to the Y2 (indicated by A′ or B′) in the Y-axis direction.

As illustrated in FIG. 7, a first light reflecting portion 50 configured by a white dot pattern is formed on the diffuser 15a on a surface facing the hot cathode tube 17. The first light reflecting portion 50 is formed at edge portions 15e in which longitudinal ends of the hot cathode tube 17 are located (edge portions close to X1 side and X2 side). In the portion of the diffuser 15a excluding the edge portions 15e, a second light reflecting portion 60 that is configured by a white dot pattern is formed such that an area of the dot pattern changes in a gradual manner. In the present embodiment, each dot of the first light reflecting portion 50 and the second light reflecting portion 60 is formed in a round shape. The dot pattern forming the first light reflecting portion 50 and the second light reflecting portion 60 is formed by printing paste containing metal oxide (such as titanium oxide), for example, on the surface of the diffuser 15a. Preferable printing means is screen printing, inkjet printing and the like. In the present embodiment, a length of a luminous range EA of the hot cathode tube 17 is substantially equal to a length of the long side of the diffuser 15a (in the X-axis direction).

The first light reflecting portion 50 and the second light reflecting portion 60 facing the hot cathode tube 17 has a light reflectance of 80% in its surface area and the diffuser 15a facing the hot cathode tube 17 has a light reflectance of 30% in its surface area. Thus, the first light reflecting portion 50 and the second light reflecting portion have a relatively high light reflectance. In the present embodiment, the light reflectance of each material is represented by an average light reflectance measured with a LAV of CM-3700d (measurement area diameter of 25.4 mm) manufactured by Konica Minolta inside the measurement circle. The light reflectance of the first light reflecting portion 50 and the second light reflecting portion 60 is measured in the following method. The first light reflecting portion 50 and the second light reflecting portion 60 are formed over an entire surface of a glass substrate and the light reflectance of the surface is measured according to the above measurement means. The light reflectance of the first light reflecting portion 50 and the second light reflecting portion 60 is preferably 80% or more, and more preferably 90% or more. Thus, as the light reflectance of the first light reflecting portion 50 and the second light reflecting portion 60 is higher, the light reflection is controlled more precisely and accurately according to a pattern form of the dot pattern such as the number of dots or the area of each dot.

Next, a light reflectance distribution of the diffuser 15a will be explained. The long-side direction (the X-axis direction and the short-side direction (the Y-axis direction) are provided for the diffuser 15a. The light reflectance of the surface of the diffuser 15a facing the hot cathode tube 17 changes according to the dot pattern of the first light reflecting portion 50 and the second light reflecting portion 60. The first light reflecting portion 50 is formed in the edge portions 15e of the diffuser 15a (the short-side edge portions, the edge portions close to the X1 end and the X2 end) in which the end portions of the hot cathode tube 17 are located. The first light reflecting portion 50 is configured by dots each having uniform area and the dots are evenly arranged in the edge portions. In other words, the first light reflecting portion 50 is formed in a portion of the edge portion 15e of the diffuser 15a that overlaps the hot cathode tube 17 (hereinafter, referred to as a light source overlapping portion DA) and in a portion of the edge portion 15e of the diffuser 15a that does not overlap the hot cathode tube 17 (hereinafter, referred to as empty area overlapping portion DN). Therefore, in the edge portions 15e of the diffuser 15a, the light reflectance is uniform to be 50% in an area between the two end portions in the short-side direction (the Y-axis direction) (indicated by A and A′ in FIGS. 8 and 9).

The second light reflecting portion 60 is formed in a portion of the diffuser 15a excluding the edge portions 15e. The light reflectance is higher in the light source overlapping portion DA than in the empty area overlapping portion DN. Specifically, the light reflectance is uniform to be 50% in the light source overlapping portion DA of the diffuser 15a. On the other hand, in the empty area overlapping portion DN of the diffuser 15a, the light reflectance decreases in a continuous and gradual manner as is farther away from the light source overlapping portion DA and is 30% that is lowest in the end portions in the short-side direction of the empty area overlapping portion DN (the Y-axis direction).

A light reflectance distribution on the diffuser 15a is determined by an area of each dot of the first light reflecting portion 50 and the second light reflecting portion 60. The light reflectance of the first light reflecting portion 50 and the second light reflecting portion 60 is higher than that of the diffuser 15a. Therefore, the light reflectance relatively increases as the area of each dot of the first light reflecting portion 50 and the second light reflecting portion 60 relatively increases, and the light reflectance relatively decreases as the area of each dot of the first light reflecting portion 50 and the second light reflecting portion 60 relatively decreases. An area of each dot of the second light reflecting portion 60 is relatively great and uniform in the light source overlapping portion DA of the diffuser 15a. An area of each dot of the second light reflecting portion 60 decreases in a continuous manner as is farther away from a border between the light source overlapping portion DA and the empty area overlapping portion DN toward the end portions in the short-side direction of the empty area overlapping portion DN. As control means for controlling the light reflectance, the area of each dot of the first light reflecting portion 50 and the second light reflecting portion 60 may be uniform and distances between the dots may be varied.

As is explained before, according to the present embodiment, the first light reflecting portion 50 is formed on the diffuser 15a in the edge portions 15e that are close to the longitudinal ends of the hot cathode tube 17. The first light reflecting portion 50 reflects light from the hot cathode tube 17 so that the light reflectance of the edge portions 15e is relatively higher than the light reflectance of portions adjacent to the edge portions 15e.

In most cases, the longitudinal end portions of the hot cathode tube 17 are non-luminous ranges NA from which light is not emitted and local dark portions are easy to be caused there. However, with the above configuration of the present embodiment, the first light reflecting portion 50 having relatively high light reflectance is formed on the edge portions 15e of the diffuser 15a that are close to the end portions of the hot cathode tube 17, and therefore, light from the hot cathode tube 17 easily reflects off the edge portions 15e. Accordingly, the light from the hot cathode tube 17 is less likely to be transmitted through the edge portions 15e of the diffuser 15a and the illumination light is slightly darkened in the edge portions 15e. This suppresses occurrence of the local dark portions that are easily recognized. Especially, even in use of the hot cathode tube 17 having a relatively short luminous range EA, local dark portions are less likely to occur in the edge portions 15e of the diffuser 15a, and this achieves power saving of the backlight device 12.

In the present embodiment, the first light reflecting portion 50 has uniform light reflectance in the edge portions 15e of the diffuser 15a. Therefore, the light from the hot cathode tube 17 reflects off the first light reflecting portion 50 uniformly, and this achieves substantially a uniform brightness distribution of light exited from the edge portions 15e of the diffuser 15a.

The first light reflecting portion 50 is configured by a dot pattern having light reflectivity. The light reflection is controlled by a pattern form (the number (the density) of dots or an area of each dot). Accordingly, uniform illumination brightness can be easily obtained.

In the present embodiment, the diffuser 15a includes the light source overlapping portion DA that overlaps the hot cathode tube 17 and the empty area overlapping portion DN that does not overlap the hot cathode tube 17. The second light reflecting portion 60 is formed in at least the light source overlapping portion DA of the diffuser 15a. The second light reflecting portion 60 reflects the light from the hot cathode tube 17 so that the light reflectance of the light source overlapping portion DA is relatively higher than the light reflectance of the empty area overlapping portion DN.

With such a configuration, light emitted from the hot cathode tube 17 first reaches the light source overlapping portion DA of the diffuser 15a that is the portion having the second light reflecting portion 60 thereon and having high light reflectance. Therefore, most of the light reflects off the light source overlapping portion DA (does not pass through the light source overlapping portion DA), and the brightness of illumination light is suppressed with respect to the light emission amount from the hot cathode tubes 17. On the other hand, the light that reflects off the light source overlapping portion DA is further reflected in the chassis 14 and the light reaches the empty area overlapping portion DN. The light reflectance of the empty area overlapping portion DN is relatively low and a larger amount of light passes through the empty area overlapping portion DN and thus predetermined brightness of illumination light is obtained. This suppresses consumption power without arranging a plurality of hot cathode tubes 17 and substantially a uniform brightness distribution is achieved in the backlight device 12.

The second light reflecting portion 60 is configured by a dot pattern having light reflectivity. The light reflection is controlled by a pattern form (the number (the density) of dots or an area of each dot). Accordingly, uniform illumination brightness can be easily obtained.

The second light reflecting portion 60 is formed such that the light reflectance decreases in a continuous and gradual manner from the portion having higher light reflectance to the portion having lower light reflectance.

The light reflectance of the second light reflecting portion 60 on the diffuser 15a decreases in a continuous and gradual manner so as to have a gradation. This makes the distribution of illumination light brightness to be moderate and the backlight device 12 can achieve a uniform distribution of illumination light brightness.

According to the present embodiment, the chassis 14 is configured such that the bottom plate 30 facing the diffuser 15a is defined in the first end portion 30A, the second end portion 30B and the middle portion 30C that is sandwiched between the first and second end portions 30A and 30B. The second end portion 30B is on the opposite end side from the first end portion 30A. One of the first end portion 30A, the second end portion 30B and the middle portion 30C corresponds to the light source installation area LA where the hot cathode tube 17 is arranged and the rest corresponds to the empty areas LN where no hot cathode tube 17 is arranged.

Thus, compared to a case in which the hot cathode tubes 17 are installed evenly in the entire chassis 14, the number of hot cathode tubes 17 is reduced and a cost reduction and power saving of the backlight device 12 are achieved.

In the chassis 14, an area of the light source installation area LA is smaller than that of the empty area LN.

In such a case that the area of the light source installation area LA is smaller than that of the empty area LN, with a configuration of the present embodiment, the light from the hot cathode tube 17 is reflected by the second light reflecting portion 60 to be guided to the empty area LN in the chassis 14. This maintains uniform illumination brightness and achieves cost reduction and power saving.

The light source installation area LA is provided in the middle portion 30C of the chassis 14.

This ensures sufficient brightness in a middle portion of the backlight device 12 and also ensures brightness in a middle portion of the display in the liquid crystal display device 10 including the backlight device 12 and the liquid crystal display device 10 obtains good visibility.

In the present embodiment, the diffuser 15a is configured by a light diffusing member that diffuses light from the hot cathode tube 17.

With this configuration, the light transmission of the light source overlapping portion DA and the empty area overlapping portion DN of the diffuser 15a is controlled by changing the light reflectance distribution of the first light reflecting portion 50 and the second light reflecting portion 60, and also the light diffusing member diffuses light. This achieves uniform brightness in the surface area of the backlight device 12.

The hot cathode tube 17 is used as the light source in the present embodiment. This improves brightness.

### First Modification of First Embodiment

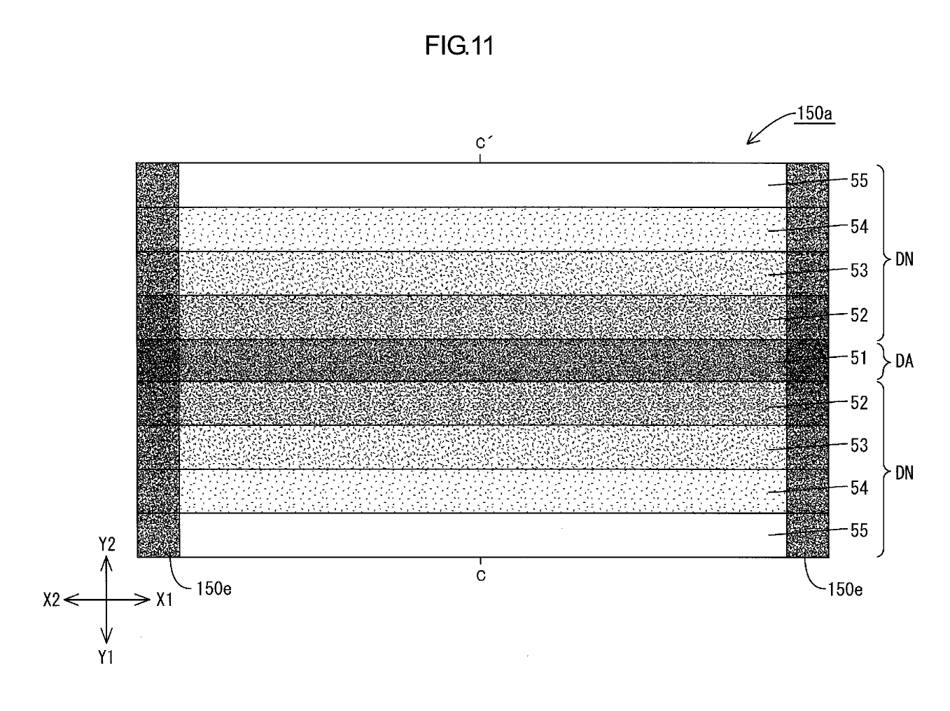

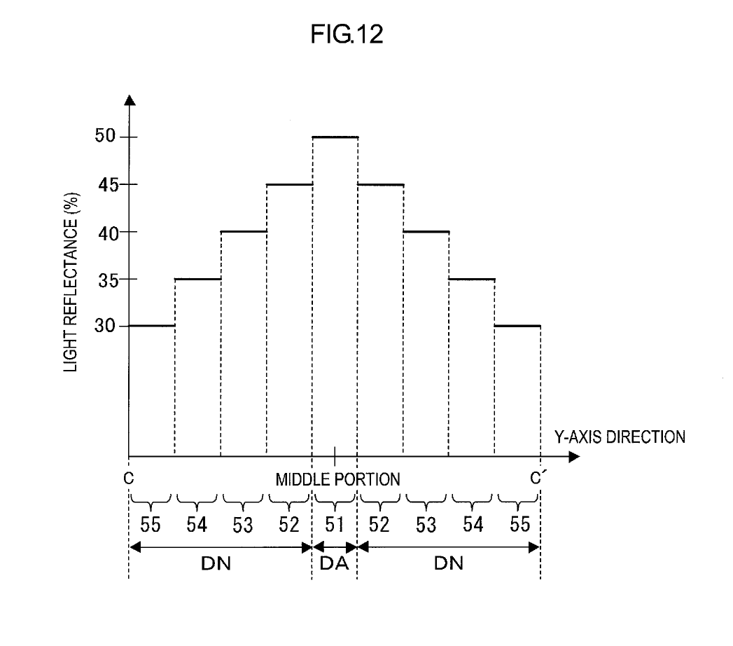

The present invention is not limited to the first embodiment, and may include a following modification. The light reflectance distribution of the diffuser 15a may be modified as illustrated in FIGS. 11 and 12. FIG. 11 is a plan view explaining a light reflectance distribution of a surface of the diffuser facing the hot cathode tube according to one modification. FIG. 12 is a graph illustrating a reflectance change in a C-C′ line of the diffuser in FIG. 10. In the following modification, the same components and parts as the first embodiment are indicated by the same symbols and will not be explained.

The light reflectance is uniform to be 50% in short-side edge portions 150e of a diffuser 150a (edge portions in which longitudinal end portions of the hot cathode tube 17 are located, an X1-end side edge portion and an X2-end side edge portion). In a portion of the diffuser 150a excluding the edge portions 150e, the light source installation area overlapping portion DA (the portion of the diffuser 150a that overlaps the light source 17) has the highest light reflectance, as illustrated in FIGS. 11 and 12. In the empty area overlapping portion DN (portion of the diffuser 150a that does not overlap the hot cathode tube 17), the light reflectance decreases in a stepwise and gradual manner from the portion closer to the light source installation area overlapping portion DA toward the portion farther therefrom. In the empty area overlapping portion DN of the diffuser 150a, the light reflectance changes in a stripe pattern along the short-side direction (Y-axis direction) of the diffuser 150a. More specifically, as illustrated in FIG. 11, a first area 51 having relatively high light reflectance is provided in the light source overlapping portion DA that is located in the middle portion of the diffuser 150a, and a second area 52 having light reflectance relatively lower than the first area 51 is provided in the empty area overlapping portion DN on each of two sides of the first area 51 and in adjacent to the first area 51. Further, a third area 53 having light reflectance relatively lower than the second area 52 is provided on a side of each second area 52 in the empty area overlapping portion DN. A fourth area 54 having light reflectance lower than the third area 53 is provided on a side of each third area 53. Further, a fifth area 55 having light reflectance lower than the fourth area 54 is provided on a side of each fourth area 54.

In this modification, as illustrated in FIG. 12, the light reflectance of the diffuser 150a is 50% in the first area 51, 45% in the second area 52, 40% in the third area 53, 35% in the fourth area 54, and 30% in the fifth area 55. The light reflectance of the diffuser 150a changes at an equal ratio. In the first area 51 to the fourth area 54, the light reflectance is determined by changing an area of each dot of the second light reflecting portion 60. The second light reflecting portion 60 is not formed in the fifth area 55 and the fifth area 55 has light reflectance of the diffuser 150a itself.

A plurality of areas 52, 53, 54, 55 having different light reflectance are defined in the empty area overlapping portion DN on the diffuser 150a. The light reflectance reduces from the second area 52 to the fifth area 55 sequentially in this order such that the light reflectance decreases in a stepwise and gradual manner from the portion closer to the light source overlapping portion DA toward the portion farther therefrom.

With such a configuration, the brightness distribution of illumination light in the empty area overlapping portion DN (the empty area LN) is made moderate and this eventually achieves a moderate illumination brightness distribution in the backlight device 12. Provided with the means for forming a plurality of areas 52, 53, 54, 55 having different light reflectance, a manufacturing method of the diffuser 150a becomes simple and this contributes to a cost reduction.

### Second Modification of First Embodiment

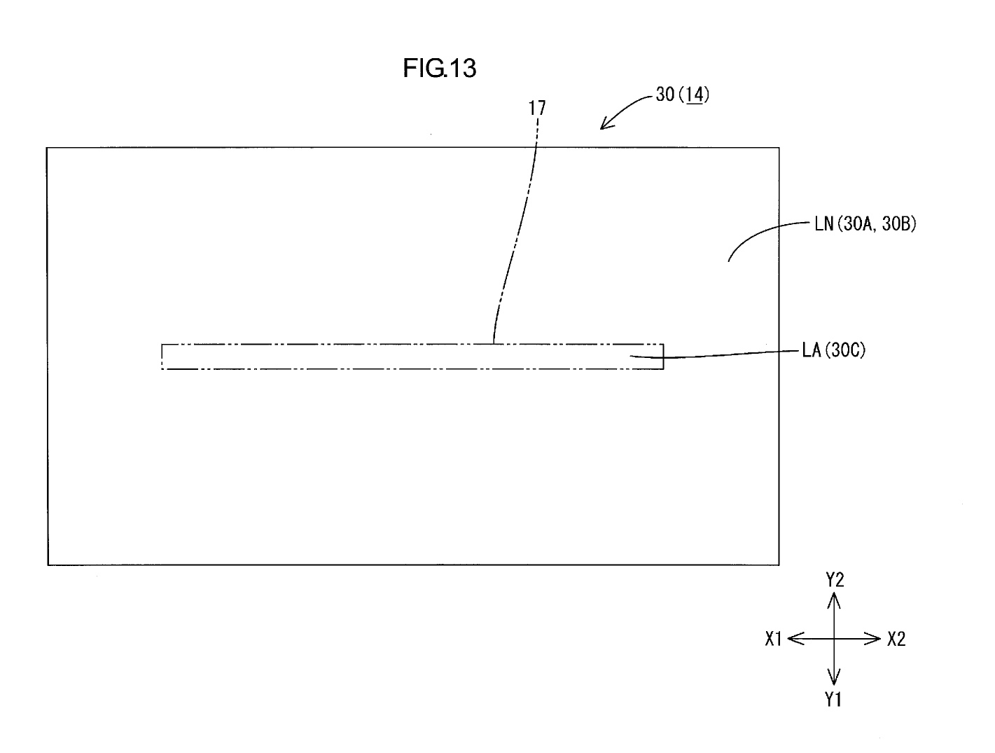

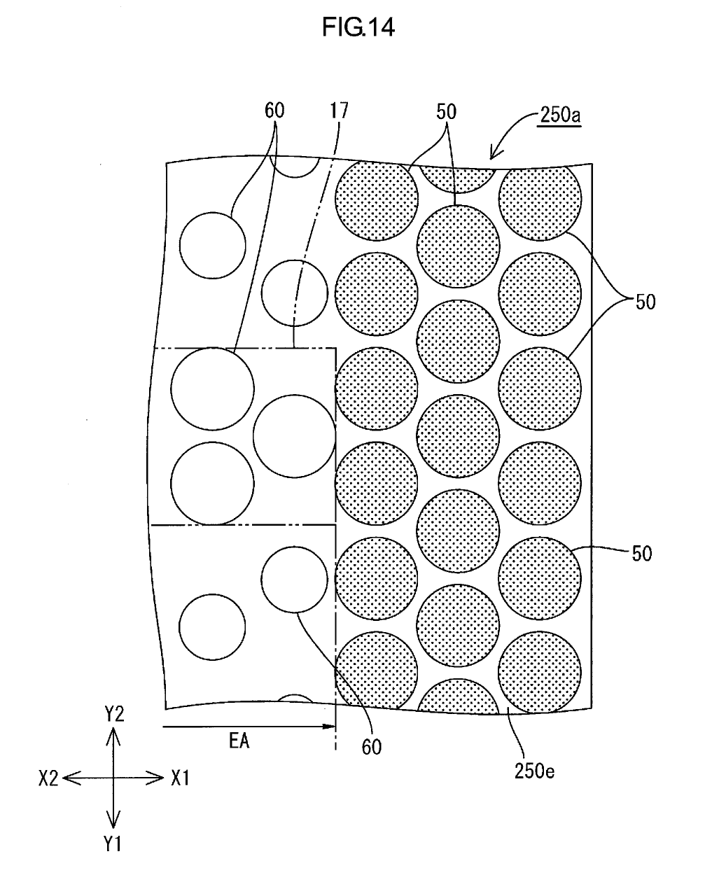

Another modification of an arrangement pattern of the hot cathode tube 17 will be explained with reference to FIGS. 13 and 14. FIG. 13 is a plan view illustrating an arrangement pattern of a hot cathode tube according to another modification. FIG. 14 is a typical view illustrating an arrangement pattern of alight reflecting portion formed on a diffuser according to another modification. In the following modification, the same components and parts as the first embodiment are indicated by the same symbols and will not be explained.

As illustrated in FIG. 13, the hot cathode tube 17 is housed in the chassis 14 such that its longitudinal direction (the axial direction) matches the long-side direction of the chassis 14. A longitudinal length of the hot cathode tube 17 is smaller than a length of the bottom plate 30 of the chassis 14 in the long-side direction. Therefore, the light source installation area LA is surrounded by the empty area LA. In such a case, as illustrated in FIG. 14, the length of the luminous range EA of the hot cathode tube 17 is smaller than the length of a diffuser 250a in the longitudinal direction of the hot cathode tube 17 (the long-side dimension). Edge portions 250e (short-side edge portions, edge portions in the X-axis direction) that are located on the diffuser 250a on end sides in the longitudinal direction of the hot cathode tube 17 do not overlap the luminous range EA of the hot cathode tube 17. No first light reflecting portion 50 that is configured by a white dot pattern is formed in the edge portions 250e. In the portion of the diffuser 250a excluding the edge portions 250e, the second light reflecting portion 60 in which an area of each dot changes in every area is formed.

As explained before, the length of the hot cathode tube 17 (the length of the luminous range EA) is relatively reduced to achieve power saving of the backlight device 12. In such a case, the light emitted from the hot cathode tube 17 is less likely to reach the edge portions 250e of the diffuser 250a and this may generate local dark portions on the edge portions 250e easily. The first light reflecting portion 50 is formed in the edge portions 250e of the diffuser 250a in this modification. This slightly darkens illumination light in entire area of the edge portions 250e of the diffuser 250a and accordingly the local dark portions are less likely to be generated.

### Second Embodiment

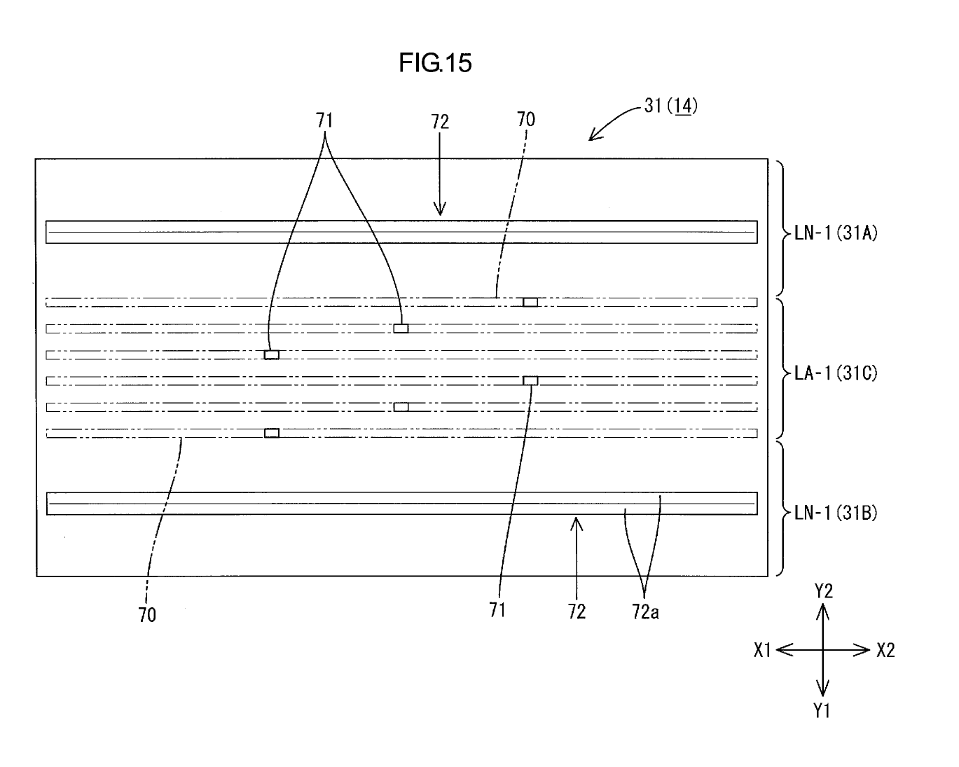

A second embodiment of the present invention will be explained with reference to FIGS. 15 to 18. In the second embodiment, the arrangement pattern of the light source is altered from the first embodiment and other configuration is similar to the first embodiment. In the second embodiment, the same components and parts as the first embodiment are indicated by the same symbols and will not be explained.

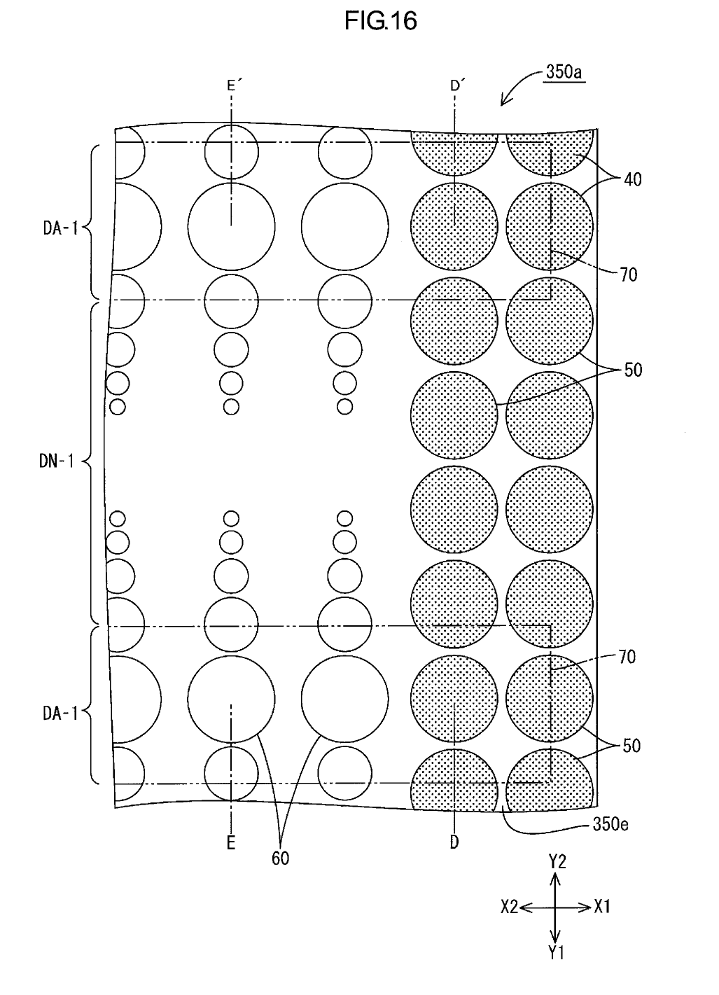

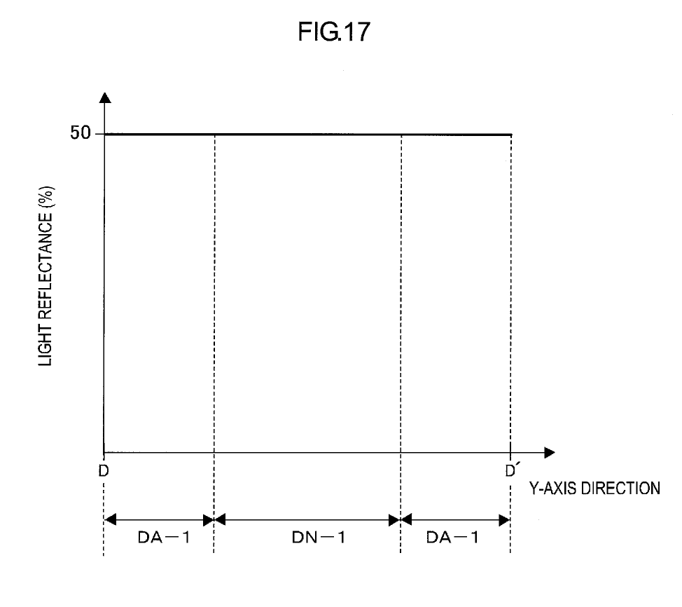

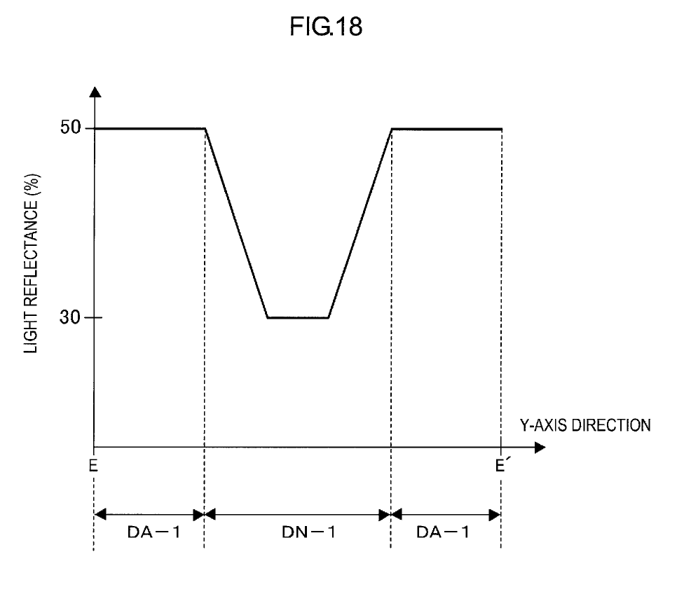

FIG. 15 is a plan view of a general construction of a chassis provided in a backlight device. FIG. 16 is a typical view illustrating an arrangement pattern of a first light reflecting portion and a second light reflecting portion formed on a surface of a diffuser that faces cold cathode tubes. FIG. 17 is a graph illustrating a reflectance change in a D-D′ line of the diffuser in FIG. 16. FIG. 18 is a graph illustrating a reflectance change in an E-E′ line of the diffuser in FIG. 16. In FIGS. 17 and 18, a horizontal axis shows the Y-axis direction (short-side direction) and the light reflectance is plotted on a graph from one point (indicated by D or E) to another point (indicated by D′ or E′) in the Y-axis direction.

Each cold cathode tube 70 has an elongated tubular shape having a diameter of 4.0 mm. A plurality of the cold cathode tubes 70 are installed in the chassis 14 such that they are arranged parallel to each other with the long-side direction (axial direction) thereof aligned along the long-side direction of the chassis 14. The cold cathode tubes 17 are arranged in a portion in the chassis 14. More specifically, as illustrated in FIG. 15, a bottom plate 31 of the chassis 14 (a portion facing a diffuser 350a) is defined in the short-side direction equally in a first end portion 31A, a second end portion 31B that is located at an end opposite from the first end portion 31A and a middle portion 31C that is sandwiched between the first end portion 31A and the second end portion 31B. The cold cathode tubes 70 are arranged in the middle portion 31C of the bottom plate 31 and a light source installation area LA-1 is formed in the middle portion 31C. On the other hand, no cold cathode tube 70 is arranged in the first end portion 31A and the second end portion 31B of the bottom plate 31 and an empty area LN-1 is formed in the first end portion 31A and the second end portion 31B. A ratio of an area of the light source installation area LA-1 occupying in an entire area of the bottom plate 31 of the chassis 14 can be changed. The ratio is preferably set in a range from 20% to 60% to achieve power saving and ensure brightness, and it is 42% in this embodiment.

In the light source installation area LA-1 of the bottom plate 31 of the chassis 14, the cold cathode tubes 70 are held by the lamp clips (not shown) to be supported with a small gap between the cold cathode tubes 70 and the bottom plate 31 of the chassis 14. Heat transfer members 71 are disposed in the gap such that a part of the cold cathode tube 70 is in contact with the bottom plate 31. Heat is transferred from the cold cathode tubes 70 that are lit and have high temperature to the chassis 14 via the heat transfer members 71. Therefore, the temperature of the cold cathode tubes 17 is lowered at the portions in which the heat transfer members 71 are arranged and the coldest points are forcibly generated there. As a result, the brightness of each one of the cold cathode tubes 70 is improved and this contributes to power saving.

In each of the empty areas LN-1 of the bottom plate 31 of the chassis 14, that is, in each of the first end portion 31A and the second end portion 31B of the bottom plate 31, a convex reflecting portion 72 extends along the long-side direction of the bottom plate 31. The convex reflecting portion 72 is made of a synthetic resin and has a surface in white color that provides high light reflectivity. Each convex reflecting portion 72 has two sloped surfaces 72a, 72a that are sloped toward the bottom plate 31 and one of which faces the cold cathode tube 70. The convex reflecting portion 72 is provided such that its longitudinal direction matches an axial direction of the cold cathode tubes 70 arranged in the light source installation area LA-1. One sloped surface 72a directs light emitted from the cold cathode tubes 70 to the diffuser 350a. The sloped surface 72a of the convex reflecting portion 72 reflects the light emitted from the cold cathode tubes 70 to the diffuser 350a side, and therefore the emitted light is effectively used.

As illustrated in FIG. 16, the first light reflecting portion 50 and the second light reflecting portion 60 that have a white dot pattern are formed on a surface of the diffuser 350a that faces the cold cathode tubes 70. The dot pattern is formed by printing paste containing metal oxide (such as titanium oxide) on the surface of the diffuser 350a. The first light reflecting portion 50 is formed in edge portions 350e of the diffuser 350a that correspond to the end portions of the cold cathode tubes 70 and an area of each dot is uniform. Therefore, the light reflectance is uniform to be 50% in the edge portions 350e of the diffuser 350a in an entire portion along the short-side direction (the Y-axis direction) (indicated by D and D′ in FIGS. 16 and 17).

The second light reflecting portion 60 is formed in a portion that mainly overlaps the cold cathode tube 70 (the light source overlapping portion DA-1) in a portion of the diffuser 350a excluding the edge portions 350e. An area of each dot of the second light reflecting portion 60 is largest in the light source overlapping portion DA-1. An area of each dot of the second light reflecting portion 60 decreases in a continuous manner from the portion closer to the cold cathode tube 70 toward the portion farther away therefrom. Therefore, as illustrated in FIG. 18, the light reflectance of the portion of the diffuser 350a excluding the edge portions 250e is highest in the light source overlapping portion DA-1 (indicated by E and E′ in FIGS. 16 and 18) and decreases in a continuous and gradual manner in the empty area overlapping portion DN-1 from the portion closer to the light source overlapping portion DA-1 toward the portion farther away therefrom.

With the above configuration, the first light reflecting portion 50 having relatively high light reflectance is formed in the edge portions 250e of the diffuser 350a that correspond to the end portions of the cold cathode tube 70. Accordingly, light emitted from the cold cathode tubes 70 easily reflects off an entire area of the edge portions 250e. Therefore, light emitted from the cold cathode tubes 70 is less likely to transmit through an entire area of the edge portion 350e of the diffuser 350a. This slightly darkens illumination light in an entire area of the edge portion 350e and this suppresses generation of local dark portions that are easily recognized.

In the present embodiment, the light source overlapping portions DA-1 having the second light reflecting portions 60 thereon have high light reflectance. Therefore, most of the light reflects off the light source overlapping portions DA-1, and the brightness of illumination light is suppressed with respect to the light emission amount from the cold cathode tubes 70. On the other hand, the light that reflects off the light source overlapping portions DA-1 is further reflected in the chassis 14 and the light reaches the empty area overlapping portions DN-1. The light reflectance of the empty area overlapping portions DN-1 is relatively low and a larger amount of light passes through the empty area overlapping portions DN-1 and thus predetermined brightness of illumination light is achieved. Thus, the light source installation area LA-1 is provided in a portion of the chassis 14 and power saving is achieved and substantially a uniform illumination brightness distribution is achieved in the backlight device 12.

The cold cathode tubes 70 are used as the light source in the present embodiment, and this extends life of the light source and light dimming is easily performed.

### Third Embodiment

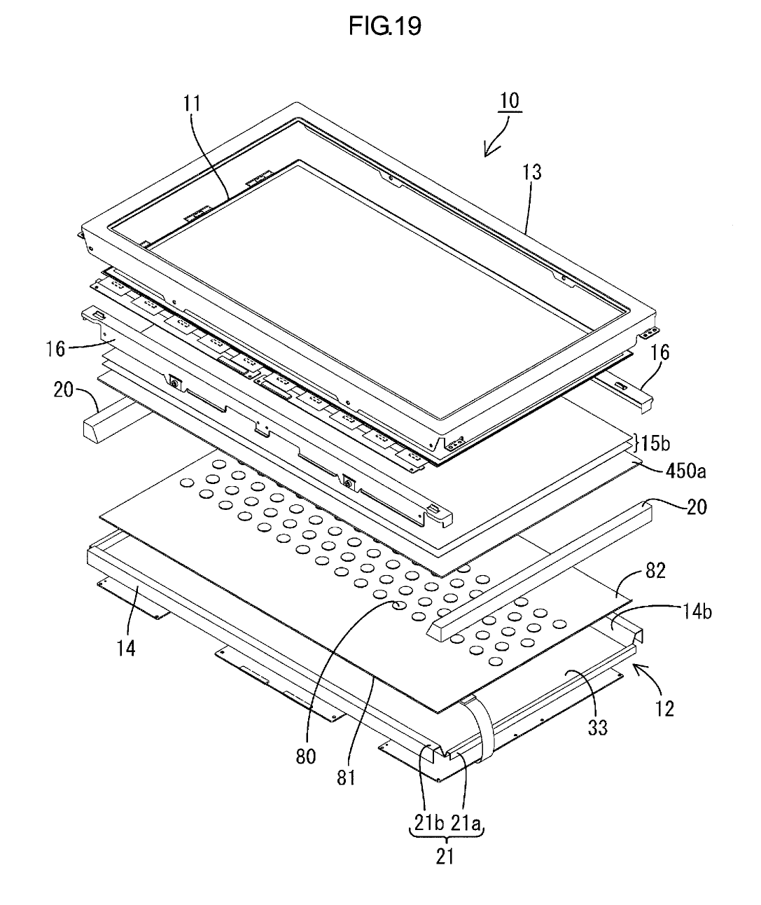

A third embodiment of the present invention will be explained with reference to FIGS. 19 to 23. In the third embodiment, the arrangement pattern of the light source is altered from the first embodiment and other configuration is similar to the first embodiment. In the third embodiment, the same components and parts as the first embodiment are indicated by the same symbols and will not be explained.

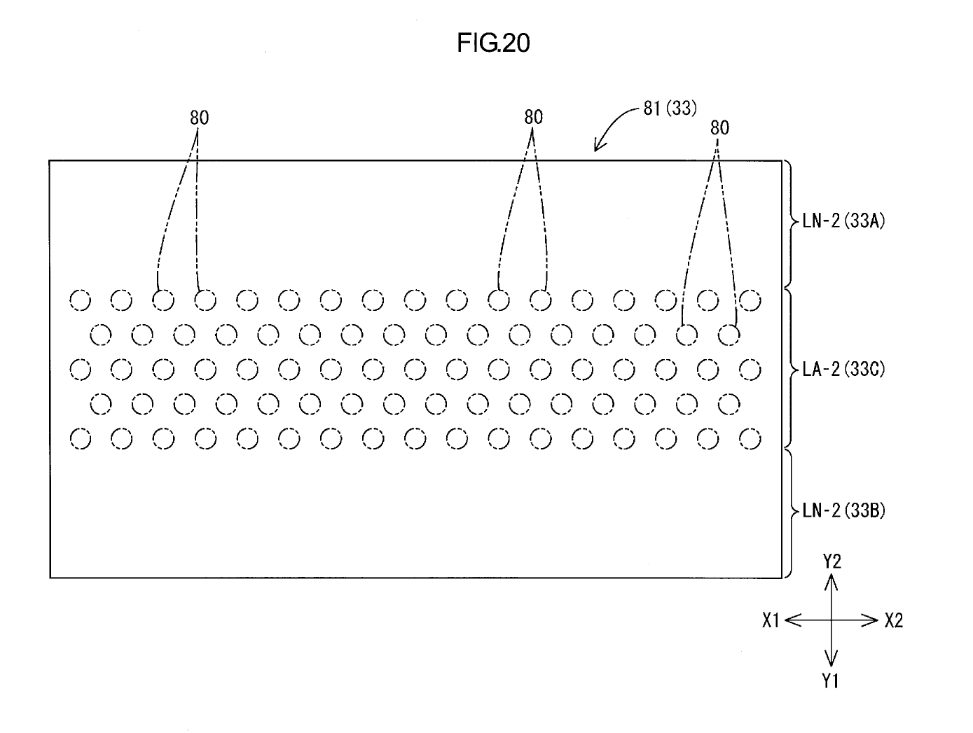

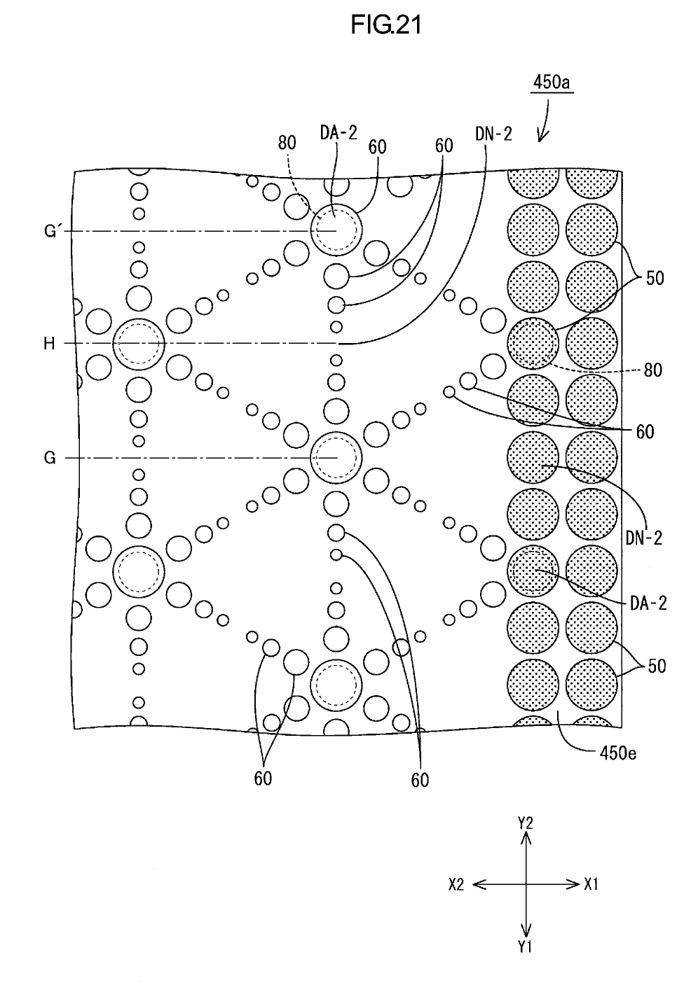

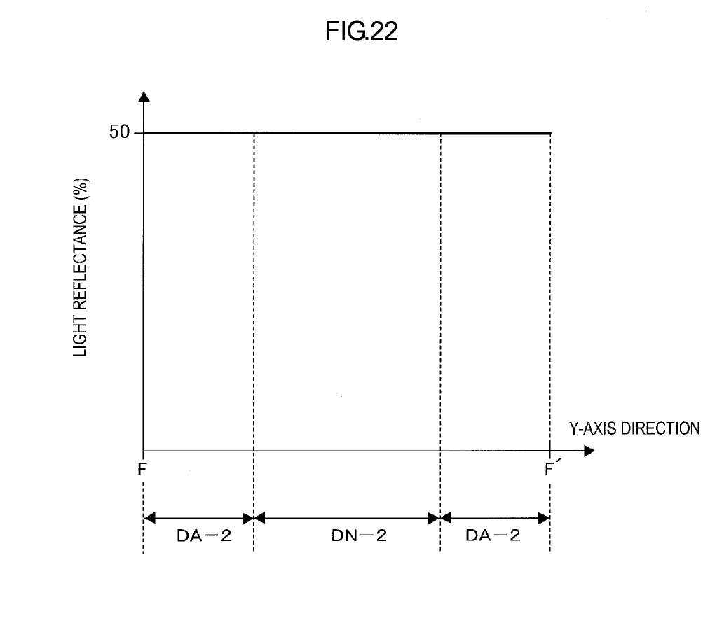

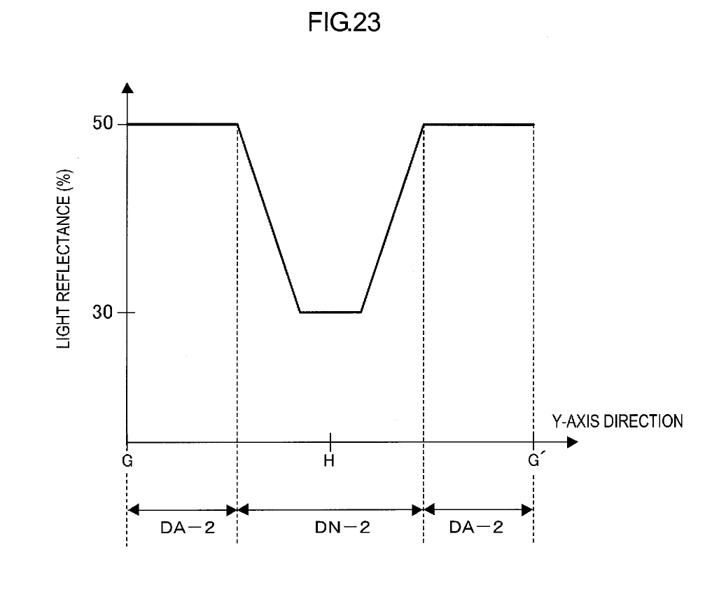

FIG. 19 is an exploded perspective view illustrating a general construction of a liquid crystal display device. FIG. 20 is a general plan view illustrating a chassis and an arrangement pattern of LED light sources. FIG. 21 is a typical view illustrating an arrangement pattern of a first light reflecting portion and a second light reflecting portion formed on a diffuser on a surface facing the LED light sources. FIG. 22 is a graph illustrating a reflectance change in an F-F′ line of the diffuser. FIG. 23 is a graph illustrating a reflectance change in a G-G′ line of the diffuser. In FIGS. 22 and 23, a horizontal axis shows the Y-axis direction (short-side direction) and the light reflectance is plotted on a graph from one point (indicated by F or G) to another point (indicated by F′ or G′) in the Y-axis direction.

An LED board 81 on which LED light sources (light sources) 80 are mounted is disposed on an inner surface side of the bottom plate 33 of the chassis 14, as illustrated in FIG. 19. The LED board 81 includes a light reflecting sheet 82 and a plurality of LED light sources 80. The light reflecting sheet 82 is disposed on a light exit side surface of the LED board 81 that is a surface facing a diffuser 450a. The LED light sources 80 are arranged to be exposed from openings (not shown) formed in the light reflecting sheet 82. As illustrated in FIG. 20, the LED light sources 80 are arranged in lines along the long-side direction of the bottom plate 33 of the chassis 14. The LED board 81 is formed of one plate corresponding to the liquid crystal panel 11 in the present embodiment. However, the LED board 81 may be divided into several pieces and the divided pieces of LED boards 81 may be arranged on a plane surface.

The light reflecting sheet 82 provided on the LED board 81 is a synthetic resin sheet having a surface in white color that provides high light reflectivity. It is placed so as to cover almost entire surface of the LED board 81 excluding the portions in which the LED light sources 80 are arranged.

Each LED light source 80 emits white light. Each LED light source 80 may have three LED chips (not shown) each of which emits light of single color of red, green and blue or may have a blue LED chip and a yellow phosphor. As illustrated in FIG. 20, the LED light sources 80 are arranged in a middle portion 33C of a bottom plate 33 of the chassis 14 and a light source installation area LA-2 is formed in the middle portion 33C. A first end portion 33A and a second end portion 33B of the bottom plate 33 are empty areas LN-2 in which no LED light source 80 is arranged. The LED light sources 80 are arranged on a plane surface in a hexagonal close-packed arrangement. Therefore, each interval between the adjacent LED light sources 80, 80 is equal.

As illustrated in FIG. 21, the first light reflecting portion 50 and the second light reflecting portion 60 each of which has a white dot pattern is formed on the diffuser 450a on a surface facing the LED light sources 80. The dot pattern is formed by printing paste containing metal oxide (such as titanium oxide) on the surface of the diffuser 450a. The light reflecting portion 50 is formed in the edge portions 450e of the diffuser 450a that are located on end sides of the linearly arranged LED light sources 80. An area of each dot of the first light reflecting portion 50 is uniform. Therefore, as illustrated in FIG. 22, the light reflectance is uniform to be 50% in the end portions 450e of the diffuser 450a along the short-side direction (the Y-axis direction) (indicated by F and F′ in FIGS. 21 and 22).

The second light reflecting portion 60 is formed in the portions of the diffuser 450a excluding the edge portions 450e. More specifically, in the portions of the diffuser 450a that overlap the LED light sources 80 (hereinafter, referred to as light source overlapping portions DA-2), the second light reflecting portion 60 is formed by forming each dot all over the entire area of each portion that overlaps the LED light source 80. Further, the second light reflecting portion 60 is also formed on portions of the diffuser 450a that do not overlap the LED light source 80 (empty area overlapping portion DN-2). In the empty area overlapping portion DN-2, the area of each dot continuously reduces in a direction away from the light source overlapping portion DA-2. In a portion of the diffuser 450a furthest from the light source overlapping portion DA-2, that is, a portion that overlaps a middle portion between the adjacent LED light sources 80, 80 (indicated by H in FIGS. 21 and 23), a dot area of the light reflecting portion 50 is smallest. As illustrated in FIG. 23, the light reflectance in the portion of the diffuser 450a excluding the edge portions 450e is highest in the light source overlapping portions DA-2 and decreases in a continuous manner as is further away from the light source overlapping portion DA-2.

With the above configuration, the first light reflecting portion 50 having relatively high light reflectance is formed in the edge portions 450e of the diffuser 450a that are located on end sides of the longitudinal direction of the linearly arranged LED light sources 80. Therefore, light emitted from the LED light sources 80 easily reflects off an entire area of the edge portions 450e. Accordingly, light emitted from the LED light sources 80 is less likely to transmit through an entire area of the edge portions 450e of the diffuser 450a. This slightly darkens illumination light in an entire area of the edge portions 450e and this suppresses generation of partial dark portions that are easily recognized.

With such a configuration, light emitted from the LED light source 80 first reaches the light source overlapping portion DA-2 of the diffuser 450a that is the portion having the second light reflecting portion 60 thereon and having high light reflectance. Therefore, most of the light reflects off the light source overlapping portion DA-2, and the brightness of illumination light is suppressed with respect to the light emission amount from the LED light source 80. On the other hand, the light that reflects off the light source overlapping portion DA-2 is reflected in the chassis 14 again and the light reaches the empty area overlapping portion DN-2. The light reflectance of the empty area overlapping portion DN-2 is relatively low and a larger amount of light passes through the empty area overlapping portion DN-2 and thus predetermined brightness of illumination light is achieved. Thus, the light source installation area LA-2 is provided in a portion of the chassis 14 and power saving is achieved and substantially a uniform brightness distribution is achieved in the backlight device 12.

The linearly arranged LED light sources 80 are used as the light source in the present embodiment, and this extends life of the light source and reduces power consumption.

### Modification of Third Embodiment

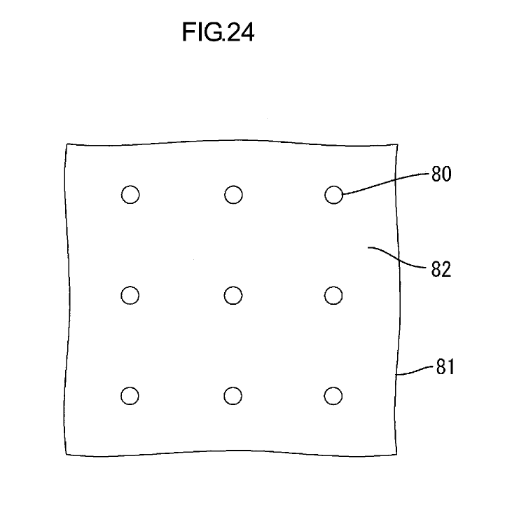

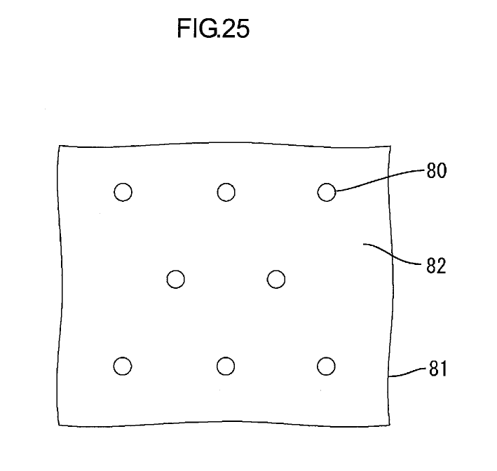

The LED light sources 80 may be arranged on the LED board 81 as illustrated in FIG. 24 or FIG. 25 according to a modification of the third embodiment. In the third embodiment, the LED light sources 80 are arranged in a hexagonal close-packed arrangement such that the adjacent LED light sources 80 are arranged at equal intervals. However, as illustrated in FIG. 24, the LED light sources 80 may be arranged vertically and horizontally in a grid. Also, as illustrated in FIG. 25, the LED light sources 80 may be arranged vertically and horizontally in a staggered arrangement such that the adjacent LED light sources 80 are offset from each other.

### Other Embodiments

The embodiments of the present invention have been described, however, the present invention is not limited to the above embodiments explained in the above description and the drawings. The following embodiments may be included in the technical scope of the present invention, for example.

(1) In the first embodiment, one hot cathode tube is arranged. A plurality of hot cathode tubes may be arranged.

(2) In the second embodiment, six cold cathode tubes are arranged. The number of cold cathode tubes may be altered, if necessary. For example, four or eight cold cathode tubes may be arranged.

(3) In the first and second embodiments, a hot cathode tube or a cold cathode tube that is a kind of a fluorescent tube (a linear light source) is used as the light source. Other different kinds of fluorescent tubes may be used as the light source. Discharge tubes other than fluorescent tubes (such as a mercury lamp) may be used as the light source.

(4) In the third embodiment, the LED that is a kind of a point light source is used as the light source. Other kinds of point light sources may be used as the light source. A planer light source such as an organic EL may be used as the light source.

(5) In the above embodiments, one kind of light source is used. A plurality kinds of light sources may be used. In one lighting device, a hot cathode tube and a cold cathode tube may be used, or a hot cathode tube and an LED may be used, or a cold cathode tube and an LED may be used, or a hot cathode tube, a cold cathode tube and an LED may be used.

(6) In the above embodiments, each dot of the dot pattern of the first light reflecting portion and the second light reflecting portion is formed in a round. However, the shape of each dot is not limited thereto but may be any shape such as a square or a polygonal shape.

(7) In the above embodiments, the optical sheet set includes a combination of a diffuser, a diffuser sheet, a lens sheet and a reflective polarizing plate. Two diffusers may be layered as optical sheets.

(8) In the above embodiments, the first reflecting portion and the second reflecting portion are formed on a surface of the diffuser that faces the light source. The first reflecting portion and the second reflecting portion may be formed on the diffuser on a surface opposite from the light source.

(9) In the above embodiments, the light source installation area is provided in the middle portion of the bottom plate of the chassis. The light source installation area may be provided in any other positions according to the amount of rays of light from the light source and use conditions of the backlight device. The light source installation area may be provided in end portions of the bottom plate or may be provided in the middle portion and one end portion of the bottom plate.

(10) In the above embodiments, the light source installation area is provided in a portion of the bottom plate of the chassis. The light source installation area may be provided in an entire area of the bottom plate.

1. A lighting device comprising:
a linearly formed light source;
a chassis configured to house the light source and have an opening for light from the light source to pass through;
an optical member provided to face the light source and cover the opening and having an edge portion on an end in a longitudinal direction of the linearly formed light source; and
a first light reflecting portion configured to reflect the light from the light source and provided in the edge portion such that light reflectance of the edge portion is relatively higher than that of a portion adjacent to the edge portion.

2. The lighting device according to claim 1, wherein the light reflectance of the first light reflecting portion is uniform in the edge portion.

3. The lighting device according to claim 1, the first light reflecting portion is configured by a dot pattern having light reflectivity.

4. The lighting device according to claim 1, wherein a length of a luminous range of the light source from which light is emitted is smaller than a length of the optical member in the longitudinal direction of the light source.

5. The lighting device according to claim 1, wherein the optical member includes a light source overlapping portion that overlaps the light source and an empty area overlapping portion that does not overlap the light source,
the lighting device further comprising:
a second light reflecting portion formed at least in the light source overlapping portion of the optical member such that the light reflectance of the light source overlapping portion is relatively hither than the light reflectance of the empty area overlapping portion, the second light reflecting portion configured to reflect the light from the light source.

6. The lighting device according to claim 5, wherein the second light reflecting portion is configured by a dot pattern having light reflectivity.

7. The lighting device according to claim 5, wherein light reflectance of the second light reflectance decreases in a continuous and gradual manner from a portion having higher light reflectance toward a portion having lower light reflectance.

8. The lighting device according to claim 5, wherein light reflectance of the second light reflectance decreases in a stepwise and gradual manner from a portion having higher light reflectance toward a portion having lower light reflectance.

9. The lighting device according to claim 1, wherein:
the chassis has a surface facing the optical member and including at least a first end portion, a second end portion, and a middle portion, the second end portion being located at an end away from the first end portion, and the middle portion being located between the first end portion and the second end portion;
at least one of the first end portion, the second end portion and the middle portion is configured as a light source installation area in which the light source is arranged, and the rest is configured as an empty area in which no light source is arranged.

10. The lighting device according to claim 9, wherein in the chassis, the light source installation area is smaller than the empty area.

11. The lighting device according to claim 9, wherein the light source installation area is provided in the middle portion of the chassis.

12. The lighting device according to claim 1, wherein the optical member is a light diffusing member for diffusing light from the light source.

13. A display device comprising:
the lighting device according to claim 1; and
a display panel configured to provide display using light from the lighting device for a display device.

14. The display device according to claim 13, wherein the display panel is a liquid crystal display panel using liquid crystal.

15. A television receiver comprising the display device according to claim 13.
